(19) United States
(12) Patent Application Publication
(10) Pub. No.: US 2026/0126416 A1
(43) Pub. Date: May 7, 2026

(54) ULTRASONIC PROBE, POSITIONING ASSISTANCE JIG, AND PREPARATION METHOD FOR ULTRASONIC PROBE

(71) Applicant: KRINWAVE TECHNOLOGY (ZHUHAI) CO.,LTD., Zhuhai (CN)

(72) Inventors: Zhiqi LIU, Shenzhen (CN); Ailun Li, Shenzhen (CN)

(21) Appl. No.: 19/434,673

(22) Filed: Dec. 29, 2025

Related U.S. Application Data
(63) Continuation of application No. PCT/CN2024/130503, filed on Nov. 7, 2024.

(30) Foreign Application Priority Data
Nov. 8, 2023 (CN) 202311482847.3

(51) Int. Cl. G01N 29/22; G01N 29/24

(52) U.S. Cl. CPC G01N 29/221; G01N 29/2437

(57) ABSTRACT

In an ultrasonic probe, a first cutting groove and a second cutting groove of a matching layer are correspondingly arranged and communicated to form piezoelectric spacers, enabling a piezoelectric layer to form multiple piezoelectric units spaced apart from each other, namely the piezoelectric units are formed by means of secondary cutting. In the matching layer of the ultrasonic probe prepared by the preparation method, the piezoelectric spacer between two adjacent piezoelectric units is formed by performing secondary cutting in opposite directions. The ratio between the width of such formed piezoelectric units and the thickness of the piezoelectric layer can reach 1/60 to 1/4.

### CROSS-REFERENCE TO RELATED APPLICATIONS

The present application is a continuation of International Application of PCT/CN2024/130503, filed Nov. 7, 2024, which claims priority to Chinese Patent Application 202311482847.3, filed Nov. 8, 2023, the entire disclosures of which are hereby incorporated herein by reference.

### TECHNICAL FIELD

The present application relates to the technical field of medical devices, and in particular to, an ultrasonic probe, a positioning assistance jig, and a preparation method for the ultrasonic probe.

### BACKGROUND

An ultrasonic probe, as a core component of an ultrasonic diagnostic device, is a device that emits ultrasonic waves into an interior of a detected object and receives ultrasonic echo signals reflected from corresponding parts. The ultrasonic diagnostic device converts the echo signals into images through a series of signal processing, and displays the images on the display device of the diagnostic device.

The core part of the ultrasonic probe is an ultrasonic transducer. A piezoelectric element in the ultrasonic transducer can convert electrical pulse excitation into ultrasonic waves and can convert the corresponding reflected echo waves in the detected object into electrical signals. The ultrasonic transducer usually further includes one or more matching layers disposed at a front end of the piezoelectric element layer, and configured to match acoustic impedance between the detected object and the piezoelectric element. The ultrasonic transducer further includes an acoustic lens disposed between the matching layers and the detected object, and configured to form acoustic beam focusing in a short axis direction. The ultrasonic transducer further includes a backing layer disposed at a rear end of the piezoelectric element layer, and configured to absorb reverse acoustic waves. The ultrasonic transducer further includes structures such as an electrode and a circuit configured to transfer signals.

For the ultrasonic probe, the center frequency is a basic acoustic parameter. The ultrasonic probe is usually used on the ultrasonic diagnostic device, and the center frequency of the ultrasonic probe is 2 MHz-20 MHz. When the ultrasonic probe is used for diagnosis in blood vessels, the frequency of the ultrasonic probe may reach 50 MHz-100 MHz.

### SUMMARY

There are an ultrasonic probe, a positioning assistance jig, and a preparation method for the ultrasonic probe according to embodiments of the present application. The technical solution is as below:

According to a first aspect of embodiments of the present application, there is provided an ultrasonic probe, including a backing layer, a piezoelectric layer, a matching layer, and an acoustic lens bonded sequentially from bottom to top, two opposite side surfaces of the piezoelectric layer respectively being a first surface and a second surface, wherein
a plurality of first cutting grooves are formed in the first surface, a cutting direction of the first cutting grooves facing the second surface from the first surface along a thickness direction of the piezoelectric layer; a plurality of second cutting grooves are formed in the second surface, a cutting direction of the second cutting grooves facing the first surface from the second surface along the thickness direction of the piezoelectric layer;
a cutting width of the first cutting grooves is the same as a cutting width of the second cutting grooves, the plurality of first cutting grooves and the plurality of second cutting grooves being formed in a one-to-one correspondence manner; the corresponding first cutting grooves and second cutting grooves are connected to form piezoelectric spacings, such that a plurality of spaced piezoelectric subunits are formed in the piezoelectric layer, and a space between two adjacent piezoelectric subunits is the piezoelectric spacing;
where a ratio of a width of the piezoelectric subunits to a thickness of the piezoelectric layer is 1/60-1/4.

According to a second aspect of embodiments of the present application, there is provided a positioning assistance jig, used for preparing the ultrasonic probe, where the positioning assistance jig includes a positioning plate and at least two positioning posts disposed on the positioning plate, the positioning posts being fixed in position on the positioning plate.

According to a third aspect of embodiments of the present application, there is provided a preparation method for an ultrasonic probe, used for preparing the ultrasonic probe, where the method includes the following steps:
piezoelectric plate positioning: providing a piezoelectric plate and a positioning assistance jig, where the positioning assistance jig includes a positioning plate and at least two positioning posts disposed on the positioning plate, the positioning posts being fixed in position on the positioning plate; positioning holes being formed in the piezoelectric plate; sleeving the piezoelectric plate on the positioning posts through the positioning holes, causing the piezoelectric plate to be fixed in position on the positioning plate;
first cutting: integrally positioning the piezoelectric plate and the positioning assistance jig on a cutting platform, selecting, by cutting equipment, a set cutting position relative to the positioning plate to cut a first surface of the piezoelectric plate to form a plurality of first cutting grooves, and then connecting the backing layer to the first surface of the piezoelectric plate; and
second cutting: selecting, by the cutting equipment, the set cutting position relative to the positioning plate to cut a second surface of the piezoelectric plate, the second surface and the first surface of the piezoelectric plate being disposed opposite to each other to form a plurality of second cutting grooves on the second surface, where a cutting position in the first cutting and a cutting position in the second cutting are both set positions relative to the positioning plate, causing cutting marks of the second cutting grooves to be aligned with and communicate with cutting marks of the first cutting grooves to form an integral cutting groove, so as to prepare the piezoelectric layer.

### BRIEF DESCRIPTION OF THE DRAWINGS

FIG. 1 is a schematic structural view of an embodiment of an ultrasonic probe of the present disclosure.

FIG. 2 is a graph of frequency response test results obtained through simulation for Example 1 of the ultrasonic probe of the present disclosure.

FIG. 3 is a graph of frequency response test results obtained through simulation for Example 2 of the ultrasonic probe of the present disclosure.

FIG. 4 is a flowchart of a preparation method for the ultrasonic probe of the present disclosure.

FIG. 5 is a schematic structural view of an embodiment of a positioning assistance jig of the present disclosure.

FIGS. 6-10 are schematic structural views of operations in the preparation method for the ultrasonic probe of the present disclosure.

### DETAILED DESCRIPTION

Typical embodiments that embody the features and advantages of the present disclosure will be described in detail in the following explanation. It should be understood that the present disclosure may have various modifications in different embodiments, all of which do not depart from the scope of the present disclosure, and the descriptions and drawings therein are essentially for illustrative purposes, rather than for limiting the present disclosure.

In the description of the present application, it should be understood that, in the embodiments shown in the accompanying drawings, the indications of directions or positional relationships (such as up, down, left, right, front, rear, etc.) are only for the convenience of describing the present application and simplifying the description, rather than indicating or implying that the referred device or element must have a specific orientation, be constructed and operated in a specific orientation. These descriptions are appropriate when these elements are in the positions shown in the accompanying drawings. If the description of the positions of these elements changes, the indications of these directions will also change accordingly.

In addition, the terms such as “first” and “second” are used only for descriptive purposes, and should not be construed as indicating or implying relative importance or implying the number of indicated technical features. Thus, the features defined with “first” and “second” may explicitly or implicitly include one or more of the features. In the description of the present application, the meaning of “plurality” is two or more, unless otherwise explicitly and specifically defined.

Currently, the lowest center frequency of the ultrasonic probe in the prior art is 2 MHz. The acoustic attenuation coefficient in the human tissues is 1 dB/cm. MHz. When the ultrasonic probe of the related technologies is used to emit ultrasonic waves to the human tissues and receive ultrasonic waves from the human tissues, for every 1 cm increase in depth, the attenuation is 4 dB. When the depth reaches 25 cm, the attenuation is 100 dB. In this case, the echo signal has been equivalent to the noise level, and thus, on the ultrasonic image, the degree to which it is difficult to accurately distinguish the lesion has been reached.

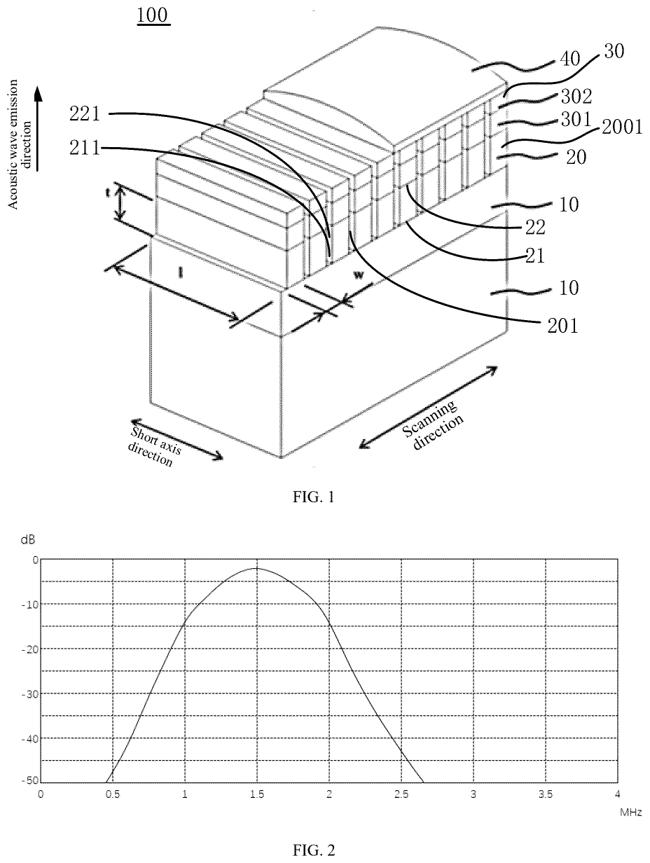

To overcome the above technical problems, the present application provides a corresponding technical solution. Specifically, referring to FIG. 1, an embodiment of the present application provides an ultrasonic probe 100, including a backing layer 10, a piezoelectric layer 20, a matching layer 30, and an acoustic lens 40 bonded sequentially from bottom to top. Two opposite side surfaces of the piezoelectric layer 20 respectively are a first surface 21 and a second surface 22.

In this embodiment, a plurality of first cutting grooves 211 are formed in the first surface 21 of the piezoelectric layer 20, a cutting direction of the first cutting grooves 211 facing the second surface 22 from the first surface 21 along a thickness direction of the piezoelectric layer 20. A plurality of second cutting grooves 221 are formed in the second surface 22 of the piezoelectric layer 20, a cutting direction of the second cutting grooves 221 facing the first surface 21 from the second surface 22 along the thickness direction of the piezoelectric layer 20.

A cutting width of the first cutting grooves 211 is the same as a cutting width of the second cutting grooves 221. The plurality of first cutting grooves 211 and the plurality of second cutting grooves 221 is formed in a one-to-one correspondence manner. The corresponding first cutting grooves 211 and second cutting grooves 221 are connected to form piezoelectric spacings 201, such that a plurality of spaced piezoelectric subunits 2001 are formed in the piezoelectric layer 20, and a space between two adjacent piezoelectric subunits 2001 is the piezoelectric spacing 201.

A ratio of a width of the piezoelectric subunits 2001 to a thickness of the piezoelectric layer 20 is 1/60-1/4. A center frequency of the ultrasonic probe 100 is 0.5 MHz-2 MHz.

In this embodiment, the first cutting grooves 211 and the second cutting grooves 221 of the piezoelectric layer 20 are formed correspondingly and connected to form the piezoelectric spacings 201, such that a plurality of spaced piezoelectric subunits 2001 are formed in the piezoelectric layer 20. The piezoelectric subunits 2001 are formed by secondary cutting of a material for preparing the piezoelectric layer 20 in the opposite direction. The thickness of the piezoelectric layer 20 is determined by the cutting depths of the two cuts that form the first cutting grooves 211 and the second cutting grooves 221. The thickness of the piezoelectric subunits 2001 is consistent with the thickness of the piezoelectric layer 20.

The ratio of the width of the piezoelectric subunits 2001 to the thickness of the piezoelectric layer 20 formed by bidirectional secondary cutting may reach 1/60-1/4. On the basis of ensuring simple and feasible processing operations, without replacing the blade of the cutting equipment, bidirectional cutting can cut thicker piezoelectric subunits 2001—for example, the thickness can reach twice that of the original piezoelectric layer—while maintaining an unchanged kerf (i.e. piezoelectric spacings 201) to achieve greater thickness, and the probe width remains unchanged. Thus, by increasing the thickness of the piezoelectric layer 20, the center frequency of the ultrasound probe 100 can be effectively reduced, so as to effectively increase the penetration capability of the ultrasonic probe 100, thereby increasing an imaging depth of the ultrasonic probe 100 and expanding an application range of the ultrasonic probe 100.

Particularly for patients who are obese or whose regions to be examined have relatively thick fat, the ultrasonic probe 100 of the present application can provide a high-quality detection effect, which is of great significance for diagnosing difficult patients such as obese patients.

Specifically, the center frequency of the ultrasonic probe 100 of the present application is 0.5 MHz-2 MHz. During actual use, by taking an operating frequency of 1 MHz as an example, when the ultrasonic probe 100 of the present application emits ultrasonic waves to the human tissues and receives ultrasonic waves from the human tissues, for every 1 cm increase in depth, the two-way attenuation is 2 dB. Compared with the ultrasonic probe in the prior art, the detection depth of the ultrasonic probe 100 of the present application can be doubled, i.e., at the same imaging level, the detection depth of the ultrasonic probe 100 of the present application can be increased by 50 cm, which may solve the problem of the difficulty in detection for obese patients caused by relatively large fat thickness, thereby guaranteeing that the ultrasonic probe 100 can still effectively perform detection and be used for diagnosing difficult patients such as obese patients.

Further, the piezoelectric layer 20 in this embodiment is made of one of a lead zirconate titanate (PZT) piezoelectric ceramic or a piezoelectric single crystal, or made of the PZT piezoelectric ceramic and the piezoelectric single crystal as bases, and a polymer material.

In this embodiment, the two opposite side surfaces of the piezoelectric layer 20 are respectively the first surface 21 and the second surface 22. An extension direction of the first surface 21 facing the second surface 22 is an acoustic wave emission direction of the ultrasonic probe 100. The backing layer 10 is disposed on the first surface 21 of the piezoelectric layer 20, and the matching layer 30 is disposed on the second surface 22 of the piezoelectric layer 20.

The piezoelectric layer 20 includes the plurality of spaced piezoelectric subunits 2001, which may be manufactured as a 1D array, a 1.5D array or a 2D array as required. The piezoelectric subunits 2001 vibrate to generate ultrasonic signals. The ultrasonic signals are formed by ultrasonic waves transmitted from the ultrasonic probe 100 in a direction indicated by an arrow in FIG. 1. Moreover, the piezoelectric subunits 2001 can receive the acoustic waves (such as ultrasonic waves reflected from a target object), and convert the ultrasonic waves into electrical signals. The electrical signals are transmitted to a receiver of an ultrasonic imaging system and are processed into images.

In this embodiment, a wavelength of an acoustic wave of the ultrasonic probe 100 propagated in the piezoelectric layer 20 is λ₁, and a width w of each of the piezoelectric subunits 2001 is 1/60λ₁-½λ₁, a width l of the piezoelectric layer 20 is ¼λ₁-30λ₁, and a thickness of the piezoelectric layer 20 is ⅛λ₁-1λ₁. The thickness t of the piezoelectric subunits 2001 is consistent with the thickness of the piezoelectric layer 20, and are both ⅛λ₁-1λ₁.

The ratio of the width of the piezoelectric subunits 2001 to the thickness of the piezoelectric layer 20 in this embodiment, i.e., the ratio of the width of the piezoelectric subunits 2001 to the thickness thereof is 1/60-1/4. As for the ultrasonic probe of the related technologies, the piezoelectric element is usually composed of a plurality of parallelly arranged piezoelectric linear array elements, and is formed by cutting an intact piezoelectric plate electroplated with an electrode. In the related technologies, a ratio of a width of each of the piezoelectric linear array elements to a thickness thereof is 1/4-1.

For the ultrasonic probe of the related technologies, when the center frequency is reduced, the thickness of the piezoelectric array elements is increased, a ratio of cutting depth to width will also increase accordingly while the size of an acoustic window is kept unchanged. Increasing the ratio of cutting depth to width requires a greater exposure of a cutting blade and a thinner blade profile, which leads to a sharp increase in blade wear. Moreover, the rigidity of the blade of the cutting equipment is reduced. During cutting, deformation easily occurs, which affects the consistency between the tool marks and the size and shape of the array elements, thereby reducing the image quality, and even directly damaging the blade and the workpiece, making processing impossible.

For the ultrasonic probe 100 of the present application, the ratio of the width of the piezoelectric subunits 2001 to the thickness thereof is 1/60-1/4. the bidirectional cutting may double a cuttable depth of the blade on basis of that the thickness of the blade retains unchanged, such that the center frequency of the processable probe is decreased to below half of the original value. Thus, the processing difficulty caused by decrease of the center frequency can also be solved while keeping the size of the acoustic window of the probe unchanged, such that the ultrasonic probe 100 can simultaneously achieve a low center frequency and facilitate processing and manufacturing.

In this embodiment, the center frequency of the ultrasonic probe 100 is 0.5 MHz-2 MHz, such that the requirement for improving the penetration capability of the ultrasonic probe 100 can be met, and processing and manufacturing of the ultrasonic probe 100 are facilitated. Settings of the width w of the piezoelectric subunits 2001 being 1/60λ₁-½λ₁ and the width l of the piezoelectric layer 20 being ¼λ₁-30λ₁ can meet the requirement on size of the ultrasonic probe 100, such that the overall structural form of the ultrasonic probe 100 is optimized.

Setting the thickness t of the piezoelectric layer 20 as ⅛λ₁-1λ₁ can not only meet the requirement on a relatively low center frequency of the ultrasonic probe 100, but also effectively guarantee the requirement on size of the ultrasonic probe 100, to prevent the ultrasonic probe 100 from being too large and too long, and ensure that the ultrasonic probe 100 can be adapted to various different detection parts and detection regions.

The backing layer 10 in this embodiment is disposed on the first surface 21 of the piezoelectric layer 20, and the backing layer 10 is in bonded fixation to the piezoelectric layer 20. The backing layer 10 may be configured to absorb the ultrasonic waves guided in the direction opposite to the direction indicated by the arrow in FIG. 1 from the piezoelectric subunits 2001, and attenuate stray ultrasonic waves deflected by the ultrasonic probe 100.

In some embodiments, the backing layer 10 may be configured as a single-layer structure or a multi-layer structure. The impedance of the backing layer 10 may be greater than the impedance of the piezoelectric subunits 2001 or less than the impedance of the piezoelectric subunits 2001.

The backing layer 10 cannot only serve as a base structure for other parts in the ultrasonic probe 100 to provide a support for structures such as the piezoelectric layer 20 and the matching layer 30, so as to guarantee the overall structural strength of the ultrasonic probe 100, but also can further effectively absorb unwanted acoustic waves radiated from back surfaces of the piezoelectric subunits 2001, so as to guarantee a high-quality detection effect of the ultrasonic probe 100.

Further, the matching layer 30 in this embodiment is disposed on the second surface 22 of the piezoelectric layer 20, and the matching layer 30 is in bonded fixation to the piezoelectric layer 20. The matching layer 30 may be made of a material positioned between the piezoelectric subunits 2001 and the target object to be imaged. By disposing the matching layer 30 therebetween, the ultrasonic waves may first pass through the matching layer 30 and be emitted from the matching layer 30, such that the probability that the ultrasonic waves are reflected at the target object is reduced, which is beneficial to propagating more acoustic wave energy to the target object, thereby achieving a purpose of improving the detection depth to a certain extent. The matching layer 30 may shorten the pulse length of the ultrasonic signals to increase the axial resolution of the signals.

In some embodiments, a wavelength of an acoustic wave of the ultrasonic probe 100 propagated in the matching layer 30 is λ₂, and a thickness of the matching layer is ⅛λ₂-½ λ₂. This configuration enables the matching layer 30 to effectively avoid unnecessary acoustic wave attenuation, while also achieving matching between the ultrasonic probe 100 and the tissues, and balancing the acoustic impedance between the ultrasonic probe 100 and the human tissues to further reduce reflection generated when the ultrasonic waves are propagated in interfaces with different impedance values, thereby effectively reducing the energy loss, and guaranteeing that more acoustic wave energy is incident into the human body, and the ultrasonic waves are smoothly propagated.

In some embodiments, the thickness of the matching layer 30 may also be set as ⅙ λ₂-½λ₂. This configuration can meet the requirement on size of the ultrasonic probe 100, such that the overall structural form of the ultrasonic probe 100 is optimized.

Two matching layers 30 are disposed in this embodiment. The two matching layers 30 are respectively a first-layer matching structure 301 and a second-layer matching structure 302. The first-layer matching structure 301 and the second-layer matching structure 302 are stacked in thickness directions thereof. Specifically, the first-layer matching structure 301 is disposed on the second surface 22 of the piezoelectric layer 20, and the second-layer matching structure 302 is disposed on a surface of the first-layer matching structure 301.

In other examples of this embodiment, one or three, five matching layers 30 may also be disposed, which is not limited herein. Corresponding layers may be disposed correspondingly according to specific detection requirements. In addition, in this embodiment, an acoustic lens 40 is disposed on the surface of the matching layer 30, and the acoustic lens 40 is disposed on a surface of the second-layer matching structure. The acoustic lens 40 can converge or diverge acoustic waves to enhance the working effect of the ultrasonic probe 100.

The center frequency of the ultrasonic probe 100 provided by the present application is measured. The frequency responses of the ultrasonic probe 100 are obtained through respectively simulating example 1 and example 2 of the ultrasonic probe 100 provided by the present application.

In the example 1 of the ultrasonic probe 100, PZT5H is used as a material of the piezoelectric layer 20, where size parameters of the piezoelectric subunits 2001 thereof are respectively as follows: the thickness t=1,080 um≈0.4λ₁, the width w=0.15 mm≈ 1/18λ₁, and the width l of the piezoelectric layer 20=12 mm≈4.5λ₁. The single-layer backing layer 10 with acoustic impedance of 3 MRayl, the double-layer matching layers 30 with acoustic impedances of 8.2 MRayl and 2.1 MRayl, and the acoustic lens 40 taking RTV silicon rubber as a raw material are used.

In the example 2 of the ultrasonic probe 100, PZT5H is used as a material of the piezoelectric layer 20, where size parameters of the piezoelectric subunits 2001 thereof are respectively as follows: the thickness t=1, 720 um≈0.43λ₁, w=0.12 mm≈ 1/33λ₁, and the width l of the piezoelectric layer 20=12 mm≈3λ1. The single-layer backing layer 10 with acoustic impedance of 3 MRayl, the double-layer matching layers 30 with acoustic impedances of 8.2 MRayl and 2.1 MRayl, and the acoustic lens 40 taking RTV silicon rubber as a raw material are used.

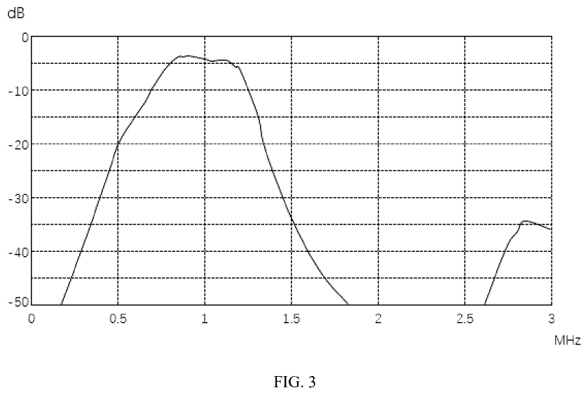

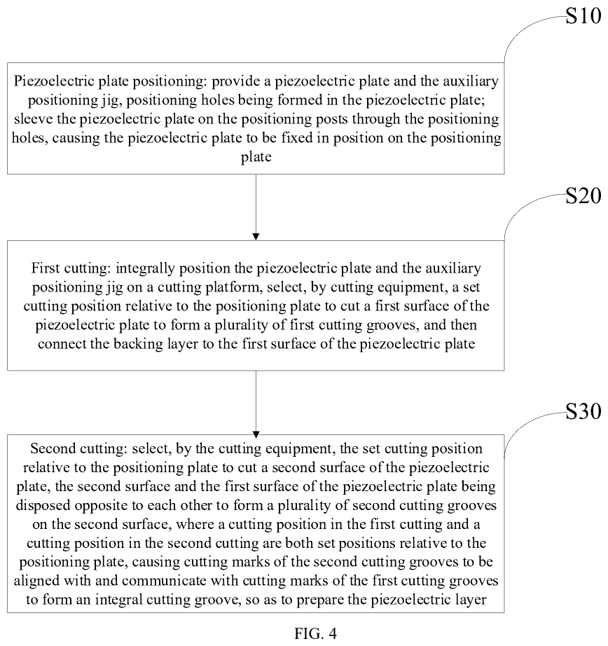

The frequency response of the example 1 of the ultrasonic probe 100 obtained through simulation is shown in FIG. 2, and the frequency response of the example 2 of the ultrasonic probe 100 obtained through simulation is shown in FIG. 3.

It may be known from FIG. 2 that the center frequency of the ultrasonic probe 100 in example 1 at −6 dB is 1.52 MHz, and the detection depth of the ultrasonic probe 100 in example 1 can be increased by more than 1.3 times compared with that of a probe with the center frequency being 2 MHz. It may be known from FIG. 3 that the center frequency of the ultrasonic probe 100 in example 2 at −6 dB is 0.98 MHz, and the detection depth of the ultrasonic probe 100 in example 2 can be increased by more than 2 times compared with that of a probe with the center frequency being 2 MHz.

In combination with example 1 and example 2 of the ultrasonic probe 100 provided by the present application, the center frequency of the ultrasonic probe 100 provided by the present application can reach 0.5 MHz-2 MHz. The detection depth of the ultrasonic probe 100 with this center frequency can be increased, which is beneficial for the ultrasonic probe 100 to be adapted to detection of deep tissues.

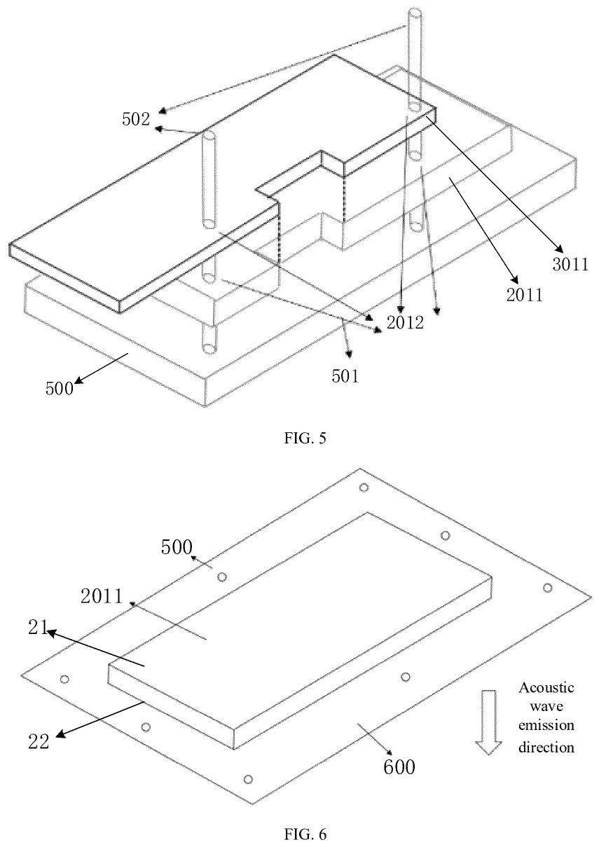

Further, an embodiment of the present application further provides a preparation method for the ultrasonic probe 100, which can be used for preparing the ultrasonic probe 100 in the above structural form. The structure of the ultrasonic probe 100 has been described above, which is not repeatedly described herein. As shown in FIG. 4, the method in this embodiment includes the following steps:

Step S10, piezoelectric plate positioning: a piezoelectric plate and the positioning assistance jig are provided. Positioning holes is formed in the piezoelectric plate. The piezoelectric plate is sleeved on the positioning posts through the positioning holes, causing the piezoelectric plate to be fixed in position on the positioning plate.

Step S20, first cutting: the piezoelectric plate and the positioning assistance jig are integrally positioned on a cutting platform, cutting equipment selects a set cutting position relative to the positioning plate to cut a first surface of the piezoelectric plate to form a plurality of first cutting grooves, and then the backing layer is connected to the first surface of the piezoelectric plate.

Step S30, second cutting: the cutting equipment selects the set cutting position relative to the positioning plate to cut a second surface of the piezoelectric plate, the second surface and the first surface of the piezoelectric plate are disposed opposite to each other to form a plurality of second cutting grooves on the second surface, where a cutting position in the first cutting and a cutting position in the second cutting are both set positions relative to the positioning plate, causing cutting marks of the second cutting grooves to be aligned with and communicate with cutting marks of the first cutting grooves to form an integral cutting groove, so as to prepare the piezoelectric layer.

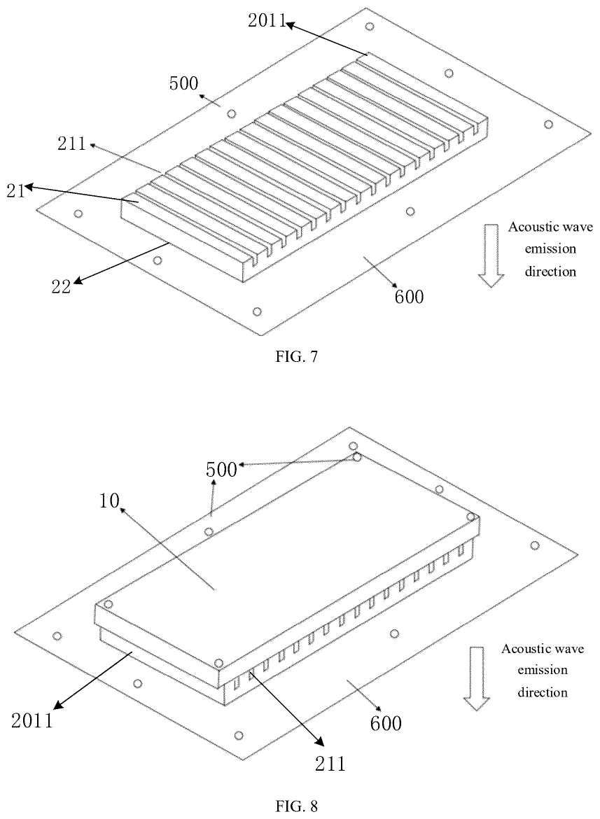

As shown in FIG. 5, this embodiment further provides a positioning assistance jig 500, including a positioning plate 501 and at least two positioning posts 502 disposed on the positioning plate 501. The positioning posts 502 are fixed in position on the positioning plate 501.

For the method provided by the present application, the positioning holes 2012 may be formed in the piezoelectric plate 2011, and the positioning holes 2012 of the piezoelectric plate 2011 are adapted to the positioning posts 502, such that the piezoelectric plate 2011 can be positioned at a set position on the positioning plate 501. When the piezoelectric plate 2011 is subjected to first cutting and second cutting, based on a fact that the piezoelectric plate 2011 is fixed in position on the positioning plate 501, and the cutting position in the first cutting and the cutting position in the second cutting are both set positions relative to the positioning plate 501, cutting marks of the second cutting grooves 221 and the first cutting grooves 211 correspond, such that the cutting marks of the first cutting and second cutting are precisely abutted, which guarantees that the shapes of the second cutting grooves 221 and the first cutting grooves 211 are uniform.

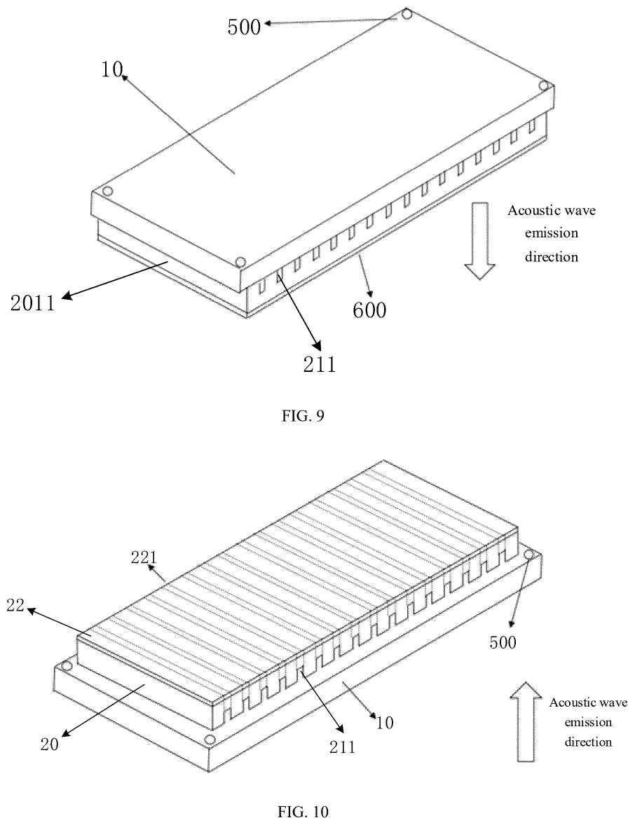

In the method provided by the present application, the first cutting direction and the second cutting direction are opposite, such that the cutting depths can be superposed. In some embodiments, the surface of the piezoelectric plate 2011 towards the backing layer 10 along the acoustic wave emission direction may be cut in the first cutting operation, and the surface of the piezoelectric plate 2011 deviated from the backing layer 10 along the acoustic wave emission direction may be cut in the second cutting operation. In some embodiments, the surface of the piezoelectric plate 2011 deviated from the backing layer 10 along the acoustic wave emission direction may be cut in the first cutting operation, and the surface of the piezoelectric plate 2011 towards the backing layer 10 along the acoustic wave emission direction may be cut in the second cutting operation. Further, in combination with FIG. 6, in Step S10, the piezoelectric plate 2011, the positioning assistance jig 500, and a flexible film 600 with an attached substrate are provided. The flexible film 600 has a certain viscosity, the substrate is configured to support the flexible film 600, and the substrate can be taken down from the flexible film 600.

The piezoelectric plate 2011 is sleeved on the positioning posts 502 through the positioning holes 2012, such that the position of the piezoelectric plate 2011 is fixed on the positioning plate 501. Two opposite surfaces of the piezoelectric plate 2011 are respectively the first surface 21 and the second surface 22. The flexible film 600 with the attached substrate is bonded to the second surface 22 of the piezoelectric plate 2011, and the size of the flexible film 600 is greater than the size of the piezoelectric plate 2011.

In some embodiments, the thickness of the flexible film 600 itself is not greater than 1/20 of the wavelength λ₁. This configuration cannot only guarantee the structural strength of the subsequent connection between the matching layer 30 and the piezoelectric layer 20 to ensure the overall structural stability of the ultrasonic probe 100, but also reduce the influence on ultrasonic wave emission to guarantee the penetration capability of the acoustic waves of the ultrasonic probe 100.

In some other embodiments, the thickness of the flexible film 600 itself is not greater than 1/100 of the wavelength λ₁, to further prevent the ultrasonic wave emission from being affected, thereby guaranteeing the detection effect of the prepared ultrasonic probe 100.

In the Step S20, in combination with FIG. 7, first cutting is performed. The piezoelectric plate 2011 and the positioning assistance jig 500 are integrally positioned on the cutting platform, and cutting equipment select a set cutting position relative to the positioning plate 501 to cut the first surface 21 of the piezoelectric plate 2011 to form the plurality of first cutting grooves 211.

In this embodiment, in the step of first cutting, a depth cut by the cutting equipment on the first surface 21 of the piezoelectric plate 2011 is not less than a half of a thickness of the piezoelectric plate 2011. Referring to FIG. 8 and FIG. 9, after the second cutting is completed, the backing layer 10 is bonded to the first surface 21 of the piezoelectric plate 2011. Moreover, the substrate on the flexible film 600 is taken down, and the part exceeding the size range of the piezoelectric plate 2011 is removed. Then the piezoelectric plate 2011, together with the positioning assistance jig 500, is integrally positioned on the cutting platform for second cutting.

In some other embodiments, the flexible film 600 may also be retained in the overall structure without being taken down. However, it is required that the flexible film should not affect the transmitting and receiving performance of the finally manufactured ultrasonic probe 100.

In addition, in some other embodiments, a conductive layer may also be disposed on the flexible film 600. The conductive layer may be made of a metal material, and may be disposed on the flexible film 600 in the form of electroplating. The conductive layer may be configured to connect an electrode to achieve the function of electrical connection and conduction.

In the Step S30, in combination with FIG. 10, second cutting is performed. The cutting equipment selects the set cutting position relative to the positioning plate 501 to cut the second surface 22 of the piezoelectric plate 2011 to form the plurality of second cutting grooves 221 in the second surface 22. The cutting position in the first cutting and the cutting position in the second cutting both are set positions relative to the positioning plate 501, causing cutting marks of the second cutting grooves 221 to be aligned with and communicate with cutting marks of the first cutting grooves 211 to form an integral cutting groove, so as to prepare the piezoelectric layer 20.

After the piezoelectric layer 20 is prepared, the matching layer 30 is correspondingly bonded to the piezoelectric layer 20 through the flexible film 600 disposed on the second surface 22 of the piezoelectric layer 20. After the matching layer 30 is bonded, the acoustic lens 40 is then bonded to the surface of the matching layer 30, so as to prepare the ultrasonic probe 100.

In other examples of this embodiment, a material for preparing the matching layer 30, i.e., the matching sheet 3011, may be provided. After the first cutting is completed, the matching sheet 3011 is first connected to the second surface 22 of the piezoelectric plate 2011, and the connecting form of the two may be bonding.

As shown in FIG. 5, the positioning holes 2012 are also formed in the matching sheet 3011, and the matching sheet 3011 is sleeved on the positioning posts 502 through the positioning holes 2012, such that the position of the matching sheet 3011 on the positioning plate 501 is fixed. In Step S30, when the second cutting is performed, the cutting equipment selects the set cutting position relative to the positioning plate 501 to cut the second surface 22 of the piezoelectric plate 2011 and the matching sheet 3011 for one time, so as to form the plurality of second cutting grooves 221 in the second surface 22 of the piezoelectric plate 2011, and the matching sheet 3011 forms a plurality of spaced matching subunits. The plurality of matching subunits form the matching layer 30, such that the matching layer 30 is prepared.

After the matching layer 30 is prepared, the acoustic lens 40 is then bonded to the surface of the matching layer 30, so as to prepare the ultrasonic probe 100. In the bonding process, a corresponding bonding jig may be used to guarantee the positional alignment of each structure during bonding, thereby ensuring the bonding precision among the structures.

For the preparation method in this embodiment, in the matching layer of the ultrasonic probe prepared by the preparation method, the piezoelectric spacing between two adjacent piezoelectric subunits is formed by secondary cutting in an opposite direction. The ratio of the width of thus formed piezoelectric subunits to the thickness of the piezoelectric layer may reach 1/60-1/4. On the basis of ensuring simple and feasible processing operations, the piezoelectric subunits may reach a relatively large thickness to effectively reduce a center frequency of the ultrasonic probe, so as to effectively increase the penetration capability of the ultrasonic probe, thereby increasing the imaging depth of the ultrasonic probe and expanding the application range of the ultrasonic probe.

Although the present disclosure has been described with reference to several typical embodiments, it should be understood that the terms used are illustrative and exemplary, rather than restrictive. Since the present disclosure can be specifically implemented in various forms without departing from the spirit or essence of the present disclosure, it should be understood that the above-described embodiments are not limited to any of the foregoing details, but should be construed broadly within the spirit and scope defined by the appended claims. Therefore, all changes and modifications that fall within the scope of the claims or their equivalents shall be covered by the appended claims.

What is claimed is:

1. An ultrasonic probe, comprising: a backing layer, a piezoelectric layer, a matching layer, and an acoustic lens bonded sequentially from bottom to top, two opposite side surfaces of the piezoelectric layer respectively being a first surface and a second surface,
wherein a plurality of first cutting grooves are formed in the first surface, a cutting direction of the plurality of first cutting grooves facing the second surface from the first surface along a thickness direction of the piezoelectric layer;
wherein a plurality of second cutting grooves are formed in the second surface, a cutting direction of the plurality of second cutting grooves facing the first surface from the second surface along the thickness direction of the piezoelectric layer;
wherein a cutting width of the plurality of first cutting grooves is the same as a cutting width of the plurality of second cutting grooves, the plurality of first cutting grooves and the plurality of second cutting grooves being formed in a one-to-one correspondence manner;
wherein each of the plurality of first cutting grooves and each of the plurality of second cutting grooves are communicated to form a piezoelectric spacing, such that a plurality of spaced piezoelectric subunits are formed in the piezoelectric layer, and a space between two adjacent piezoelectric subunits is the piezoelectric spacing; and
wherein a ratio of a width of each piezoelectric subunit to a thickness of the piezoelectric layer is 1/60-1/4.

2. The ultrasonic probe according to claim 1, wherein a center frequency of the ultrasonic probe is 0.5 MHz-2 MHz.

3. The ultrasonic probe according to claim 1, wherein a wavelength of an acoustic wave of the ultrasonic probe propagated in the piezoelectric layer is M, and the width of each piezoelectric subunit is 1/60λ₁-½λ₁.

4. The ultrasonic probe according to claim 1, wherein a wavelength of an acoustic wave of the ultrasonic probe propagated in the piezoelectric layer is λ₁, and a width of the piezoelectric layer is ¼λ₁-30λ₁.

5. The ultrasonic probe according to claim 1, wherein a wavelength of an acoustic wave of the ultrasonic probe propagated in the piezoelectric layer is λ₁, and the thickness of the piezoelectric layer is ⅛λ₁-1λ₁.

6. The ultrasonic probe according to claim 1, wherein the matching layer is formed by one or more layers arranged in a stacked manner in respective thickness directions thereof.

7. The ultrasonic probe according to claim 1, wherein a wavelength of an acoustic wave of the ultrasonic probe propagated in the matching layer is λ₂, and a thickness of the matching layer is ⅛λ₂-½λ₂.

8. The ultrasonic probe according to claim 1, wherein a thickness of the matching layer is ⅙λ₂-½λ₂.

9. The ultrasonic probe according to claim 1, wherein the piezoelectric layer is made of one of a lead zirconate titanate (PZT) piezoelectric ceramic or a piezoelectric single crystal, or made of the PZT piezoelectric ceramic and the piezoelectric single crystal, as bases, and a polymer material.

10. The ultrasonic probe according to claim 1, wherein one or more the backing layer is formed by one or more layers arranged in a stacked manner in respective thickness directions thereof.

11. A positioning assistance jig, used for preparing an ultrasonic probe, wherein the positioning assistance jig comprises a positioning plate and at least two positioning posts disposed on the positioning plate, the at least two positioning posts being fixed in position on the positioning plate,
wherein the ultrasonic probe comprises a backing layer, a piezoelectric layer, a matching layer, and an acoustic lens bonded sequentially from bottom to top, two opposite side surfaces of the piezoelectric layer respectively being a first surface and a second surface;
wherein a plurality of first cutting grooves are formed in the first surface, a cutting direction of the plurality of first cutting grooves facing the second surface from the first surface along a thickness direction of the piezoelectric layer;
wherein a plurality of second cutting grooves are formed in the second surface, a cutting direction of the plurality of second cutting grooves facing the first surface from the second surface along the thickness direction of the piezoelectric layer;
wherein a cutting width of the plurality of first cutting grooves is the same as a cutting width of the plurality of second cutting grooves, the plurality of first cutting grooves and the plurality of second cutting grooves being formed in a one-to-one correspondence manner;
wherein each of the plurality of first cutting grooves and each of the plurality of second cutting grooves are communicated to form a piezoelectric spacing, such that a plurality of spaced piezoelectric subunits are formed in the piezoelectric layer, and a space between two adjacent piezoelectric subunits is the piezoelectric spacing; and
wherein a ratio of a width of each piezoelectric subunit to a thickness of the piezoelectric layer is 1/60-1/4.

12. A preparation method for an ultrasonic probe, configured to prepare the ultrasonic probe, wherein the method comprises the following steps:
piezoelectric plate positioning: providing a piezoelectric plate and a positioning assistance jig, wherein the positioning assistance jig comprises a positioning plate and at least two positioning posts disposed on the positioning plate, the at least two positioning posts being fixed in position on the positioning plate, and wherein positioning holes are formed in the piezoelectric plate; sleeving the piezoelectric plate on the at least two positioning posts through the positioning holes, causing the piezoelectric plate to be positioned on the positioning plate;
first cutting: positioning the piezoelectric plate and the positioning assistance jig on a cutting platform, selecting, by a cutting equipment, a set cutting position relative to the positioning plate to cut a first surface of the piezoelectric plate to form a plurality of first cutting grooves, and then connecting backing layers to the first surface of the piezoelectric plate; and
second cutting: selecting, by the cutting equipment, the set cutting position relative to the positioning plate to cut a second surface of the piezoelectric plate, the second surface and the first surface of the piezoelectric plate being disposed opposite to each other to form a plurality of second cutting grooves on the second surface, wherein a cutting position in the first cutting and a cutting position in the second cutting are both set positions relative to the positioning plate, causing each of cutting marks of the plurality of second cutting grooves to be aligned with and communicate with a corresponding cutting mark of the plurality of first cutting grooves to form an integral cutting groove, so as to prepare a piezoelectric layer.

13. The method according to claim 12, wherein in the step of first cutting, a depth cut by the cutting equipment on the first surface of the piezoelectric plate is not less than a half of a thickness of the piezoelectric plate.

14. The method according to claim 12, wherein in the step of piezoelectric plate positioning, a flexible film is provided, and the flexible film is bonded to the second surface of the piezoelectric plate.

15. The method according to claim 14, wherein a wavelength of an acoustic wave of the ultrasonic probe propagated in the piezoelectric layer is λ₁, and a thickness of the flexible film is less than or equal to 1/20λ₁.

16. The method according to claim 12, wherein after the second cutting is completed, a matching layer is then connected to the second surface of the piezoelectric layer, and then an acoustic lens is connected to a surface of the matching layer, such that the ultrasonic probe is prepared.

17. The method according to claim 12, wherein after the first cutting is completed, a matching sheet is connected to the second surface of the piezoelectric layer;
wherein in the step of second cutting, the cutting equipment selects the set cutting position relative to the positioning plate to cut the second surface of the piezoelectric plate and the matching sheet to form the plurality of second cutting grooves in the second surface, and the matching sheet forms a plurality of spaced matching subunits, such that a matching layer is prepared; and
wherein an acoustic lens is connected to a surface of the matching sheet, such that the ultrasonic probe is prepared.
